(19) United States
(12) Patent Application Publication
(10) Pub. No.: US 2026/0058920 A1
(43) Pub. Date: Feb. 26, 2026

(54) MESSAGE PROCESSING METHOD, PROGRAMMABLE NETWORK CARD DEVICE, PHYSICAL SERVER, AND STORAGE MEDIUM

(71) Applicant: CLOUD INTELLIGENCE ASSETS HOLDING (SINGAPORE) PRIVATE LIMITED, Singapore (SG)

(72) Inventor: Yilong LYU, Hangzhou, Zhejiang (CN)

(21) Appl. No.: 19/112,128

(22) PCT Filed: Sep. 21, 2023
(86) PCT No.: PCT/CN2023/120288

§ 371 Date: Mar. 14, 2025

(30) Foreign Application Priority Data
Sep. 26, 2022 (CN) 202211177345.5

(51) Int. Cl. H04L 49/00; H04L 45/74

(52) U.S. Cl. CPC H04L 49/70; H04L 45/74

(57) ABSTRACT

Embodiments of the present disclosure provide a message processing method, a programmable network card device, a physical server, and a storage medium. In the embodiments of the present disclosure, a virtual switch in software form is deployed on the programmable network card device, and a message parsing acceleration module and a hardware message queue providing message parsing service for the virtual switch are implemented on the programmable network card device based on programmable hardware. The embodiments of the present disclosure can greatly reduce the message parsing cost of the virtual switch and achieve high message forwarding performance. At the same time, all operations except parsing of the header information of the message are performed by the virtual switch in software form, which can meet flexible application requirements and ensure rapid iteration and evolution of the application requirements.

### CROSS-REFERENCE TO RELATED APPLICATIONS

The present disclosure is a National Stage of International Application No. PCT/CN2023/120288, filed on Sep. 21, 2023, which claims priority to Chinese Patent Disclosure No. 202211177345.5, filed to China National Intellectual Property Administration on Sep. 26, 2022 and entitled “MESSAGE PROCESSING METHOD, PROGRAMMABLE NETWORK CARD DEVICE, PHYSICAL SERVER, AND STORAGE MEDIUM”. The two applications are hereby incorporated by reference in their entireties.

### TECHNICAL FIELD

The present disclosure relates to the field of cloud computing technology, and in particular, to a message processing method, a programmable network card device, a physical server, and a storage medium.

### BACKGROUND

The Moore's Law slowdown has caused the marginal cost of the performance growth of a general-purpose Central Processing Unit (CPU) to rise rapidly. In order to cope with the development of network bandwidth from the mainstream 10G to 25G, 40G, 100G, 200G and even 400G, cloud vendors began to adopt hardware acceleration solutions to offload network virtualization processing to the intelligent network card, and the most typical is to offload the virtual switch (vswitch) to the intelligent network card.

In this way, messages sent from a host to which the intelligent network card belongs or received from physical network pass through the hardware of the intelligent network card to match flow entries. If a message matches a flow table entry on the hardware, the message is directly forwarded by the hardware to achieve hardware acceleration of the vswitch and improve forwarding performance.

Application requirements of cloud-based networks are characterized by rapid iteration and evolution, so that hardware logic of intelligent network cards needs to have strong flexibility to quickly adapt to the iteration and evolution of application requirements. However, hardware is often unable to meet the same flexibility, if the hardware logic is implemented with ASIC can not be modified, even if the use of FPGA is limited by development cycle and hardware resources, it can not support flexible application requirements.

### SUMMARY

The present disclosure provides a message processing method, a programmable network card device, a physical server, and a storage medium to improve forwarding performance and adapt to flexible application requirements.

An embodiment of the present disclosure provides a physical server, including: a physical machine and a programmable network card device, a virtual machine is deployed on the physical machine, and a virtual switch for data forwarding between different virtual machines is deployed on the programmable network card device:

where the programmable network card device includes a message parsing acceleration module and a hardware message queue implemented based on programmable hardware; the message parsing acceleration module is configured to receive a target message that needs to be forwarded by the virtual switch, and parse header information of the target message to obtain metadata information of the target message; and write the target message and the metadata information to the hardware message queue for the virtual switch to read:

the virtual switch runs on a processor of the programmable network card device and is configured to read the target message and the metadata information from the hardware message queue, and obtain information to be matched of the target message according to the metadata information; and match the information to be matched in a forwarding flow table, and forward the target message according to a matched flow table entry.

An embodiment of the present disclosure provides a programmable network card device, where a virtual switch for data forwarding between different virtual machines is deployed on the programmable network card device, the programmable network card device includes: a processor, and a message parsing acceleration module and a hardware message queue implemented based on programmable hardware:

the message parsing acceleration module is configured to receive a target message that needs to be forwarded by the virtual switch, and parse header information of the target message to obtain metadata information of the target message; and write the target message and the metadata information to the hardware message queue for the virtual switch to read:

the virtual switch runs on the processor and is configured to read the target message and the metadata information from the hardware message queue, and obtain information to be matched of the target message according to the metadata information; and match the information to be matched in a forwarding flow table, and forward the target message according to a matched flow table entry.

An embodiment of the present disclosure further provides a message processing method applied to a message parsing acceleration module implemented based on programmable hardware on a programmable network card device, a virtual switch is deployed on the programmable network card device, and the programmable network card device further includes a hardware message queue implemented based on programmable hardware, the method includes:
receiving a target message that needs to be forwarded by the virtual switch; parsing header information of the target message to obtain metadata information of the target message; and writing the target message and the metadata information to the hardware message queue for the virtual switch to obtain information to be matched of the target message according to the metadata information and forward the target message according to a flow table entry matched by the information to be matched in a forwarding flow table.

An embodiment of the present disclosure further provides a message processing method applied to a virtual switch on a programmable network card device, where the programmable network card device further includes a message parsing acceleration module and a hardware message queue implemented based on programmable hardware, and the method includes: reading a target message and metadata information of the target message written by the message parsing acceleration module from the hardware message queue, where the metadata information is obtained by parsing header information of the target message by the message parsing acceleration module; obtaining information to be matched of the target message according to the metadata information, and matching the information to be matched in a forwarding flow table; and forwarding the target message according to a matched flow table entry.

An embodiment of the present disclosure further provides a computer-readable storage medium storing a computer program, where the computer program, when executed by a processor, causes the processor to implement the steps in the message processing method that can be executed by a virtual switch provided by the embodiment of the present disclosure.

An embodiment of the present disclosure further provides a computer program product including a computer program/instruction, the computer program/instruction, when executed by a processor, causes the processor to implement the steps in any one of the message processing methods provided by the embodiment of the present disclosure.

In the embodiments of the present disclosure, a virtual switch in software form is deployed on a programmable network card device, and a message parsing acceleration module and a hardware message queue providing message parsing service for the virtual switch are implemented on the programmable network card device based on programmable hardware. Based on this, a message that needs to be forwarded by the virtual switch first pass through the message parsing acceleration module. The message parsing acceleration module parses header information of the message to obtain metadata information of the message, and writes the message and its metadata information to the hardware message queue. In this way, the virtual switch can directly read the message and its metadata information from the hardware message queue, obtain information to be matched of the message according to the metadata information, match the information to be matched in a forwarding flow table, and forward the message according to a matched flow table entry. In this process, the virtual switch does not need to parse the header information of the message, but uses hardware to parse the header information of the message and provides a parsing result to the virtual switch, which can greatly reduce the message parsing cost of the virtual switch and achieve high message forwarding performance. At the same time, all operations except parsing of the header information of the message are performed by the virtual switch in software form, which can meet flexible application requirements and ensure rapid iteration and evolution of the application requirements.

### BRIEF DESCRIPTION OF DRAWINGS

The drawings illustrated herein are used to provide a further understanding of the present disclosure and form part of the present disclosure, and schematic embodiments of the present disclosure and their descriptions are used to interpret the present disclosure and do not constitute undue qualification of the present disclosure. In the drawings:

FIG. 1 is a structural diagram of a physical server provided by an exemplary embodiment of the present disclosure.

FIG. 2a to FIG. 2c is a schematic diagram of a message structure and its parsing status provided by an exemplary embodiment of the present disclosure.

FIG. 3 is a flow schematic diagram of a fast/slow path of a physical server for message forwarding provided by an exemplary embodiment of the present disclosure.

FIG. 4 is a structural diagram of a programmable network card device provided by an exemplary embodiment of the present disclosure.

FIG. 5 is a flow schematic diagram of a message processing method provided by an exemplary embodiment of the present disclosure.

FIG. 6 is a flow schematic diagram of another message processing method provided by an exemplary embodiment of the present disclosure.

FIG. 7 is a structural diagram of a message processing apparatus provided by an exemplary embodiment of the present disclosure.

### DESCRIPTION OF EMBODIMENTS

In order to make the purpose, technical solution and advantages of the present disclosure more clear, the following will be combined with the specific embodiments and the corresponding drawings of the present disclosure to describe the technical solution of the present disclosure clearly and completely. It is clear that the embodiments described are only part of the embodiments of the present disclosure and not the whole of the embodiments. Based on the embodiments in the present disclosure, all other embodiments obtained by ordinary skilled persons in the field without creative labor are within the scope of protection in the present disclosure.

The existing hardware acceleration solutions of virtual switches cannot adapt to the iteration and evolution of application requirements, and the flexibility is poor. To solve this technical problem, in embodiments of the present disclosure, on the one hand, a virtual switch in software form is deployed on a programmable network card device, and on the other hand, a message parsing acceleration module and a hardware message queue are implemented on the programmable network card device based on programmable hardware. A message that needs to be forwarded by the virtual switch first pass through the message parsing acceleration module. The message parsing acceleration module parses header information of the message and provides a parsing result to the virtual switch, which can greatly reduce the message parsing cost of the virtual switch and achieve high message forwarding performance. At the same time, all operations except parsing of the header information of the message are performed by the virtual switch in software form, which can meet flexible application requirements and ensure rapid iteration and evolution of the application requirements.

The technical solutions provided by the embodiments of the present disclosure are described in detail in conjunction with the attached drawings.

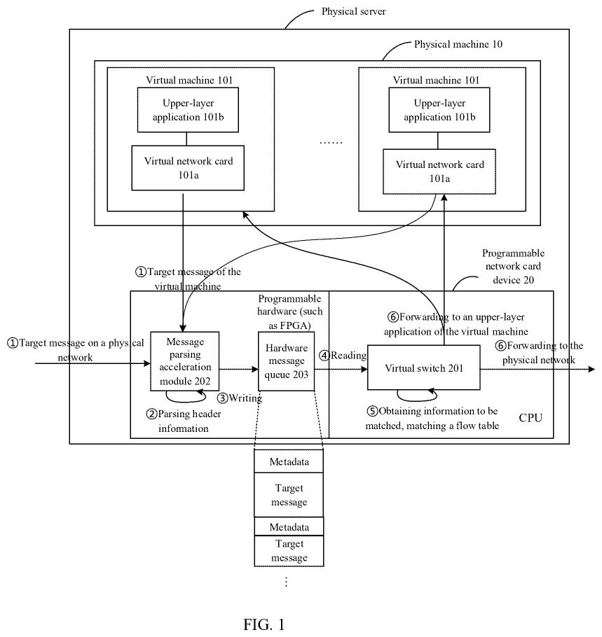

FIG. 1 is a structural diagram of a physical server provided by an exemplary embodiment of the present disclosure. The physical server can be applied to a cloud network system as an infrastructure in the cloud network system. As shown in FIG. 1, the physical server includes: a physical machine, at least one virtual machine 101 is deployed on the physical machine 10. Each virtual machine 101 has a virtual network card 101a and an upper-layer application 101b. The virtual network card 101a is a network card that is simulated by software or hardware mode on the virtual machine 101 using virtualization technology. The virtual network card 101a serves as a network interface of the virtual machine 101 to connect the virtual machine 101 to the network and provide data transmission services for the upper-layer application 101b on the virtual machine 101.

In this embodiment, in order to forward data between different virtual machines 101, a virtual switch is deployed on a physical machine, the virtual switch is responsible for data forwarding between different virtual machines 101 on the same physical machine 10 and between different virtual machines 101 on different physical machines 10. For example, when data is transmitted between a virtual machine E1 and a virtual machine E2 on the same physical machine, the virtual machine E1 first transmits data to a virtual switch through its virtual network card, and the virtual switch forwards the data to the virtual machine E2 through the virtual network card of the virtual machine E2. For example, data is transmitted between a virtual machine F and a virtual machine G on different physical machines, the virtual machine F uses its virtual network card to transmit the data to a virtual switch on the physical machine, and the virtual switch transmits the data to the physical network card on the physical machine, and the physical network card transmits the data to the physical network card of the physical machine to which the virtual machine G belongs, the physical network card transmits the data to the virtual switch of the physical machine to which the virtual machine G belongs, and the virtual switch transmits the data to the virtual machine G through the virtual network card of the virtual machine G.

In addition to the physical machine 10, the physical server of the embodiment of the present disclosure further includes a programmable network card device 20. The programmable network card device 20 can be implemented as a pluggable structure and is plugged into the physical machine 10. The pluggable mode has the advantages of flexibility and scalability, but is not limited to this. For example, the programmable network card device 20 can also be directly integrated on the physical machine 10. The programmable network card device 20 provides a network card function and can be configured as a physical network card for the physical machine 10 to forward network traffic.

In addition, some functions of the physical machine 10 can also be offloaded to the programmable network card device 20. The programmable network card device 20 consists of two parts, one is a central processing unit (CPU) and a corresponding operating system (OS), which can be responsible for carrying some software functions running on the physical machine, such as network management and configuration and data processing, which does not need high performance. The other part is a programmable hardware part, which is responsible for accelerating the processing of various software functions on the physical machine 10 and supporting hardware offload of various software functions. For example, some operations that need to be executed by the CPU on the physical machine 10, such as message encapsulation or decapsulation, network address translation (NAT), rate limiting, and really simple syndication (RSS), etc. can be offloaded on the programmable network card device 20 and implemented in hardware mode, thereby reducing the burden on the CPU of the physical machine.

In implementation form, the programmable network card device 20 can be a SmartNiC or a data processing unit (DPU), which is not limited here. In addition, the programmable hardware on the programmable network card device 20 can be any hardware device that supports programmability, such as an application specific integrated circuit (ASIC), a system on chip (SOC), field programmable gate array (FPGA), or complex programmable logic device (CPLD).

In the embodiment of the present disclosure, a virtual switch can be offloaded from the physical machine 10 to the programmable network card device 20 to implement with the help of the resource of the programmable network card device 20. As shown in FIG. 1, a virtual switch 201 can be implemented in software mode on the programmable network card device 20, that is, a virtual switch in software form can be deployed on the programmable network card device 20. The virtual switch in software form needs to run on the CPU of the programmable network card device 20, so that the central processing unit (CPU) on the programmable network card device 20 can run the corresponding program code of the virtual switch to realize the data forwarding function of the virtual switch.

The following describes the process of the upper-layer application 101b on the virtual machine 101 perform data transmission through the virtual switch 201. In the following example, a virtual machine A0 includes an upper-layer application A1 and a virtual network card A2, the physical machine where the virtual machine A0 resides includes a programmable network card device A3, and a virtual switch A4 is implemented on the programmable network card device A3, the data transmission process of the upper-layer application A1 is described.

Data forwarding scenario C1: the upper-layer application A1 receives a message from an upper-layer application BI on other physical machines, performs some processes on the message, and forwards the processed message. Specifically, a physical network card on the programmable network card device A3 receives a message from the upper-layer application BI on the other physical machines and provides the message to a virtual switch A4, the virtual switch A4 provides the message to the virtual network card A2 on the virtual machine A0 based on a forwarding flow table, and the virtual network card A2 provides the message to the upper-layer application A1 on the virtual machine A0. The upper-layer application A1 performs some processes on the messages and provides the processed message to the virtual network card A2, and the virtual network card A2 provides the processed message to the virtual switch A4, and the virtual switch A4 provides the processed message to the physical network card on the programmable network card device A3 based on the forwarding flow table, the physical network card on the programmable network card A3 provides the processed message to the upper-layer application BI through network transmission.

Data sending scenario C2: the upper-layer application A1 generates a message and sends the message to an upper-layer application on other virtual machines on the same physical machine or an upper-layer application on other physical machines. The upper-layer application A1 provides the generated message to the virtual network card A2, and the virtual network card A2 provides the message to the virtual switch A4. In a case that the upper-layer application A1 instructs the message to be sent to the upper-layer application on other virtual machines on the same physical machine, the virtual switch A4 provides the message to the virtual network card of other virtual machines based on the forwarding flow table, and the virtual network card of other virtual machines provide the message to the upper-layer application on other virtual machines. In a case that the upper-layer application instructs the message to be sent to the upper-layer application on other physical machines, the virtual switch A4 provides the message to the physical network card on the programmable network card device A3 based on the forwarding flow table, and the physical network card on the programmable network card device A3 provides the message to the physical network card on other physical machines for the physical network card of other physical machines to provide the received message to the upper-layer applications of other physical machines.

Data receiving scenario C3: the upper-layer application A1 receives a message from the upper-layer application on other virtual machines. Specifically, if the virtual machine where the upper-layer application A1 resides is located on the same physical machine as other virtual machines, the virtual switch A4 receives the message from the upper-layer application on other virtual machines and provides the message to the virtual network card A2 based on the forwarding flow table. Then the virtual network card A2 provides the received message to the upper-layer application A1 for the upper-layer application A1 to process the received message. Alternatively, if the virtual machine where the upper-layer application A1 resides is located on a different physical machine from other virtual machines, the physical network card on the programmable network card device A3 receives the message from the upper-layer application on the other physical machines and provides the message to virtual switch A4, and the virtual switch A4 provides the message to virtual network card A2 based on the forwarding flow table, and the virtual network card A2 provides the received message to the upper-layer application A1 for the upper-layer application A1 to process the received messages.

In the three application scenarios listed above, the virtual switch is implemented in software mode and forward the message based on the forwarding flow table. The forwarding flow table contains multiple flow entries, and each flow table entry corresponds to a data flow. The flow table entry mainly includes match information and action information. The match information is key information corresponding to the action information, and mainly includes information that uniquely identifies the data flow. The match information, for example, may be a message quintuple. The message quintuple can be a source/destination IP address, source/destination port number, and protocol type. Of course, the match information may also be a message triplet or a message heptuple, etc. The action information includes execution action on the message, such as encapsulation/decapsulation, forwarding, and rate limiting.

During the message forwarding process, the virtual switch depends on the CPU of the programmable network card to parse the message and obtain the information to be matched of the message, matches the information to be matched in the matching information in the forwarding flow table, processes the message according to the action information in a matched flow table entry. The whole process depends on the CPU resources of the programmable network card. The message forwarding performance is affected by CPU performance. In order to improve the message forwarding performance of the virtual switch, hardware offload for the virtual switch can be implemented on the programmable network card device 20 based on the hardware offload function of the programmable network card device 20. That is, a switch acceleration module implemented based on the programmable network card device 20 is implemented on the programmable network card device 20, the switch acceleration module provides data forwarding acceleration service for the virtual switch 201.

Specifically, the forwarding flow table used by the virtual switch 201 is configured to the switch acceleration module. In this way, during the message sending and receiving process, any message that needs to be forwarded by the virtual switch first arrives at the switch acceleration module, and the switch acceleration module parses the message to obtain information to be matched of the message, performs matching in matching information of the forwarding flow table according to the information to be matched, and performs message forwarding according to a matched flow table entry. Finally, the virtual switch 201 in software form that is replaced by hardware performs message forwarding. In a case that the matched flow table entry exists, the message does not need to be sent to the virtual switch 201 for software processing, which improves the message forwarding speed. In addition, by using the switch acceleration module to forward the message, the participation of the virtual switch 201 can be reduced, and then CPU resources of the programmable network card device 20 occupied for running the virtual switch 201 are reduced, and the performance of the programmable network card device is improved.

However, because the upper-layer application based on cloud network has the characteristics of rapid iteration and evolution, it often needs to change matching information and/or action information in the flow table entry, which requires the switch acceleration module to have strong flexibility, and to change the match information and/or action information in the hardware flow table entry adaptively according to the iteration and evolution of the upper-layer application, whereas the switch acceleration module implemented based on programmable hardware cannot meet similar flexibility. Therefore, in the following embodiments of the present disclosure, a new message processing solution that a message is parsed based on a hardware assistance for a virtual switch in software form realizing acceleration is provided.

As shown in FIG. 1, a programmable hardware part of a programmable network card device 20 implements a message parsing acceleration module 202 and a hardware message queue 203, instead of a switch acceleration module, and a virtual switch 201 in software form runs on a processor of the programmable network card device 20. The programmable hardware in the programmable network card device 20 can be such as FPGA, CPLD, ASIC, or SOC, etc., In this case, the message parsing acceleration module 202 and the hardware message queue 203 are implemented using FPGA, CPLD, ASIC, or SOC. In an implementation, the hardware message queue 203 can be a ring queue, but is not limited to this. In addition, the hardware message queue can be one or more, which is not limited here. In FIG. 1, a hardware message queue is illustrated as an example. The acceleration process of virtual switch 201 in software form based on the message parsing acceleration module 202 and the hardware message queue 203 is as follows:

A message that needs to be forwarded by the virtual switch 201 first arrive at the message parsing acceleration module 202. To facilitate description and differentiation, the message that needs to be forwarded by the virtual switch 201 is called a target message. In FIG. 1, the target message shown in \textcircled{1} can be a message sent by an upper-layer application on any virtual machine on a physical machine 10, or a message of an upper-layer application from another physical machine 10 received by a physical network card on a programmable network card device from on the physical network.

The message parsing acceleration module 202 receives the target message that needs to be forwarded by the virtual switch 201, and parses header information of the target message to obtain metadata information of the target message, as shown by \textcircled{2} in FIG. 1; writes the target message and metadata information to the hardware message queue 203 for the virtual switch 201 to read, as shown by \textcircled{3} in FIG. 1. The metadata information includes some information obtained by parsing the header information of the target message, which helps the virtual switch 201 to quickly obtain the information to be matched in the target message. The information to be matched of the target message can be a quintuple, triplet, or heptuple, which corresponds to a matching information type in a forwarding flow table. The specific information depends on the requirements of the upper-layer application.

The virtual switch 201 runs on the CPU of the programmable network card device 20 and can read the target message and the metadata information from the hardware message queue 203, as shown in 4) in FIG. 1. It should be noted that an action performed by virtual switch 201 is an action performed by the CPU of the programmable network card device for running the virtual switch 201. In an implementation, in a case that the message parsing acceleration module 202 writes the target message and the metadata information to the hardware message queue 203, the hardware message queue 203 can generate an interrupt signal, and the CPU reads the target message and the metadata information from the hardware message queue 203 according to the interrupt signal generated by the hardware message queue 203. Alternatively, in an implementation, the CPU can periodically poll the hardware message queue 203 and read the target message and the metadata information from the hardware message queue 203 in a case that it finds a new target message and metadata information in the hardware message queue 203.

As shown in 5 in FIG. 1, after reading the target message and the metadata information from the hardware message queue 203, the virtual switch 201 obtains information to be matched of the target message according to the metadata information, matches the information to be matched in a forwarding flow table, and forwards the target message according to a matched flow table entry, as shown by 6 in FIG. 1. Forwarding the target message includes forwarding the target message to the physical network or to the upper-layer application of any virtual machine on the physical machine 10.

For the forwarding performance of software virtual switch 201, the impact on forwarding performance mainly includes two parts, one is the parsing of the header information of the message, and the other is execution of a processing action in the flow table entry. However, the execution of the processing action in the flow table entry often changes with the rapid iteration and evolution of the upper-layer application. Therefore, in this embodiment, instead of implementing complete forwarding logic in hardware mode in a same way as the switch acceleration module, the message parsing acceleration module 202 and the hardware message queue 203 assist the virtual switch 201 to parse the header information of the message and provide a parsing result to the virtual switch 201. By reducing the overhead of parsing the header information of the message, the forwarding performance of the virtual switch 201 is improved. Meanwhile, all operations except parsing of the header information of the message are performed by the virtual switch 201 in software form, which can meet flexible application requirements and ensure rapid iteration and evolution of application requirements.

It is explained here that the message parsing acceleration module 202 only needs to complete the parsing of the header information of the message and does not need to match the forwarding flow table. Therefore, different from the implementation mode of the switch acceleration module, it does not need to send the forwarding flow table to the message parsing acceleration module 202, that is, it is not necessary to maintain the forwarding flow table on the hardware, but only at a software level.

In each embodiment of the present disclosure, the implementation mode of the message parsing acceleration module 202 to parse the header information of the target message is not limited here, and the following two implementation modes can be adopted but not limited to:
implementation mode A1: pre-parsing mode. In this implementation mode, after receiving the target message, the message parsing acceleration module 202 can pre-parse the header information of the target message to obtain respective position offsets of multiple protocol fields in the header information; and generate the metadata information according to the respective position offsets of the multiple protocol fields in the header information. Pre-parsing refers to a parsing process of parsing the header information of the target message to obtain the respective position offsets of the multiple protocol fields in the header information. In this embodiment, the metadata information includes at least the respective position offsets of the multiple protocol fields contained in the header information of the target message.

Specifically, when arriving at the programmable network card device, the target message is sent to the message parsing acceleration module 202 first. The message parsing acceleration module 202 pre-parses the header information of the target message in hardware mode, obtains position offset of each protocol field from the outside to the inside in the header information of the message, and saves the position offset of each protocol field. The position offset of each protocol field describes a start position of each protocol field in the header information of the message. In an implementation, the position offset can be the number of bytes relative to the first byte of the message header.

It should be noted that the protocol fields contained in the header information of different types of messages are different, and the embodiment of the present disclosure does not limit this. The message parsing acceleration module 202 can pre-parse header information of various types of messages and obtain the position offset of each protocol field contained in the header information. The following are some examples.

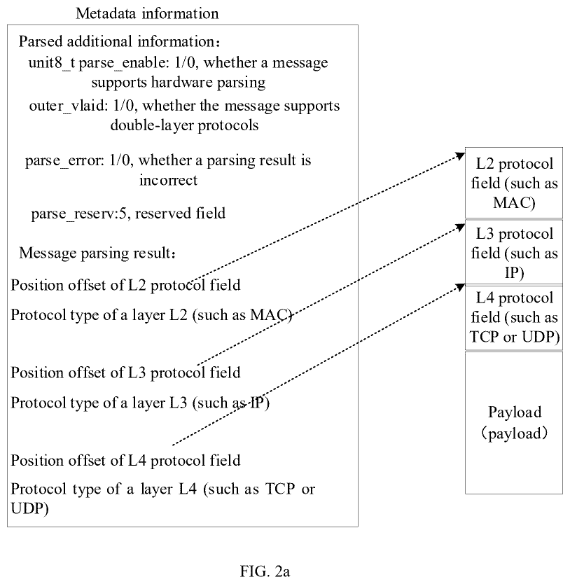

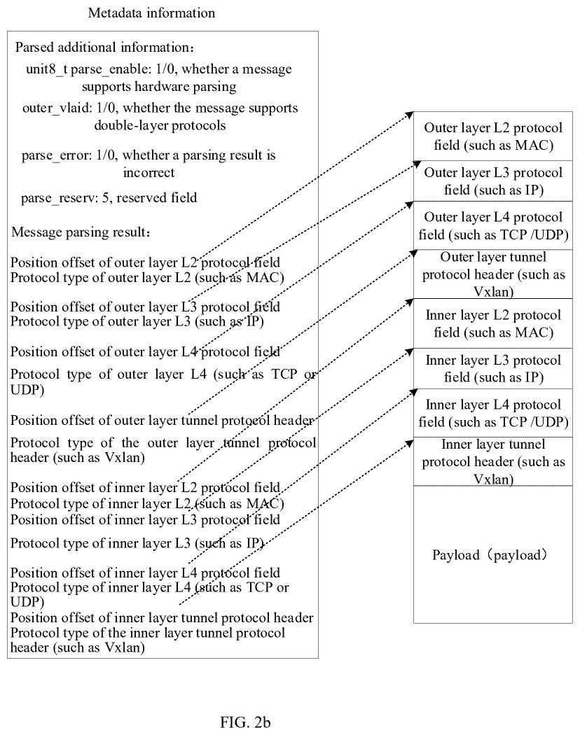

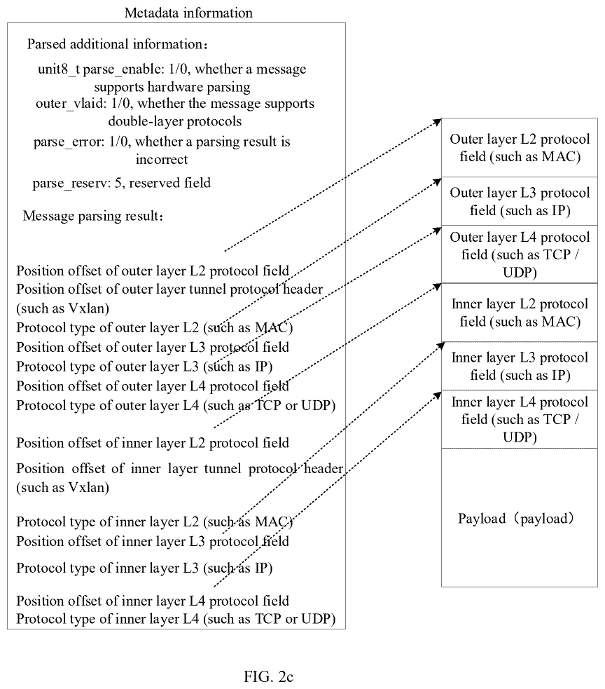

In some application scenarios, a tunnel protocol is not used for message transmission, and header information of such message contains only single-layer protocol fields. For example, the header information of the message contains Layer 2 (L2) protocol field, Layer 3 (L3) protocol field, and Layer 4 (L4) protocol field from the outside to the inside. FIG. 2a shows a message structure of a kind of single-layer protocol field. In FIG. 2a, L2 protocol field mainly refers to MAC field; L3 protocol field mainly refers to IP field, which can be IPV4 field or IPV6 field; L4 protocol field refers to TCP field or UDP field. Further, as shown in FIG. 2a, the message parsing acceleration module 202 pre-parses the header information of the message, and can obtain a position offset of the L2 protocol field and a protocol type of L2 layer (such as MAC), a position offset of the L3 protocol field and a protocol type of L3 layer (such as IP), a position offset of the L4 protocol field and a protocol type of L4 layer (such as TCP or UDP) etc. as metadata information. In other words, the metadata information includes not only the position offset of each protocol field, but also the protocol type of each protocol field. The protocol type information is used to distinguish the corresponding protocol field.

In other application scenarios, the tunnel protocol is used for message transmission, and tunnel encapsulation is used as a dividing point. The header information of the message contains double-layer protocol fields, for example, outer layer protocol fields and inner layer protocol fields. In an implementation, the tunnel protocol can be a vlan or a vxlan. In some scenarios, the outer protocol fields from the outside to the inside include outer layer L2 protocol field, outer layer L3 protocol field, outer layer L4 protocol field, and outer layer tunnel protocol field. Accordingly, the inner protocol fields from the outside to the inside include inner layer L2 protocol field, inner layer L3 protocol field, inner layer L4 protocol field and inner layer tunnel protocol field. In other scenarios, the outer protocol fields from the outside to the inside include the outer layer L2 protocol field, the outer layer L3 protocol field and the outer layer L4 protocol field, and the outer layer tunnel protocol field is embedded in the outer layer L2 protocol field. Accordingly, the inner protocol field from the outside to the inside include the inner layer L2 protocol field, the inner layer L3 protocol field and the inner layer L4 protocol field, and the inner layer tunnel protocol field is embedded in the inner layer L2 protocol field.

FIG. 2b shows a message structure of a kind of double-layer protocol field. In FIG. 2b, header information of this kind of message from the outside to the inside contains outer layer L2 protocol field, outer layer L3 protocol field, outer layer L4 protocol field, outer layer tunnel protocol header, inner layer L2 protocol field, inner layer L3 protocol field, inner layer L4 protocol field and inner layer tunnel protocol header. The outer layer or inner layer L2 protocol field refers to the MAC field, the outer layer or inner layer L3 protocol field refers to the IP field, the outer layer or inner layer L4 protocol field refers to the TCP or UDP field, and the outer layer or inner layer tunnel protocol header can be the vlan or vxlan protocol. Further, as shown in FIG. 2b, the message parsing acceleration module 202 pre-parses the header information of the message, and can obtain a position offset of the outer layer L2 protocol field and a protocol type of the outer layer L2 (such as MAC), a position offset of the outer layer L3 protocol field and a protocol type of the outer layer L3 (such as IP), a position offset of the outer layer L4 protocol field and a protocol type of the outer layer L4 (such as TCP or UDP), a position offset of the outer layer tunnel protocol header and a protocol type of the outer layer tunnel protocol header (such as vlan or vxlan), and a position offset of the inner layer L2 protocol field and a protocol type of the inner layer L2 (such as MAC), a position offset of the inner layer L3 protocol field and a protocol type of the inner layer L3 (such as IP), a position offset of the inner layer L4 protocol field and a protocol type of the inner layer L4 (such as TCP or UDP), a position offset of the inner layer tunnel protocol header and a protocol type of the inner layer tunnel protocol header (such as vlan or vxlan) etc. as metadata information. In other words, the metadata information includes not only the position offset of each protocol field, but also the protocol type of each protocol field. The protocol type information is used to distinguish the corresponding protocol field.

FIG. 2c shows a message structure of another double-layer protocol field. In FIG. 2c, header information of this kind of message from the outside to the inside contains outer layer L2 protocol field, outer layer L3 protocol field, outer layer L4 protocol field, inner layer L2 protocol field, inner layer L3 protocol field and inner layer L4 protocol field successively. Outer layer tunnel protocol field is embedded in the outer layer L2 protocol field, and inner layer tunnel protocol field is embedded in the inner layer L2 protocol field. Further, as shown in FIG. 2c, the message parsing acceleration module 202 pre-parses the header information of the message, and can obtain a position offset of the outer layer L2 protocol field, a position offset and a protocol type of the outer layer tunnel protocol header (such as vlan or vxlan), a protocol type of outer layer L2 (such as MAC), a position offset of the outer layer L3 protocol field and a protocol type of the outer layer L3 (such as IP), a position offset of the outer layer L4 protocol field and a protocol type of the outer layer L4 (such as TCP or UDP), and a position offset of the inner layer L2 protocol field, a position offset and a protocol type of the inner layer tunnel protocol header (such as vlan or vxlan), and a protocol type of the inner layer L2 (such as MAC), a position offset of the inner layer L3 protocol field and a protocol type of the inner layer L3 (such as IP), a position offset of the inner layer L4 protocol field and a protocol type of the inner layer L4 (such as TCP or UDP) etc. as metadata information. In other words, the metadata information includes not only the position offset of each protocol field, but also the protocol type of each protocol field. The protocol type information is used to distinguish the corresponding protocol field.

After obtaining the metadata information of the target message, the message parsing acceleration module 202 writes the target message and the metadata information to the hardware message queue 203 for the virtual switch 201 to read. In the implementation mode A1, the virtual switch 201 reads the target message and the metadata information from the hardware message queue 203, and obtains a value of each protocol field corresponding to a specified protocol type from the header information of the target message as the information to be matched according to the respective position offsets of the multiple protocol fields in the metadata information.

The specified protocol type can be determined according to the requirements of the upper-layer application. For example, it can be one of L3 protocol type (such as IP), L4 protocol type (such as TCP or UDP protocol), L2 protocol type (such as MAC protocol), or tunnel protocol type (such as vlan or vxlan) or a combination thereof. The implementation of the information to be matched varies according to the different specified protocol type. For example, if the specified protocol type is L4 protocol type in the message structure shown in FIG. 2b or FIG. 2c, the information to be matched and the matching information in the forwarding flow table are implemented as hexatuples (source IP, destination IP, L4 protocol type, source port, destination port, VNI). The VNI is a Vxlan Network Identifier that represents a broadcast domain in a vlan or vxlan network. For example, if the specified protocol type is the L4 protocol type in the message structure shown in FIG. 2a, the information to be matched and the matching information in the forwarding flow table is implemented as a quintuple (source IP address, destination IP address, L4 protocol type, source port, and destination port).

After obtaining the information to be matched, the virtual switch 201 matches the information to be matched in the forwarding flow table. Specifically, the information to be matched is matched with the matching information in each flow table entry in the forwarding flow table. If a flow table entry is matched, the target message is forwarded according to action information in the matched flow table entry. In this embodiment, the matching of the flow table entry is regarded as a fastpath mode, which includes the message parsing process of the message parsing acceleration module 202, the process of the virtual switch 201 matching the forwarding flow table, and the process of forwarding the message according to the matched flow table entry.

Furthermore, in an implementation, if no flow table entry is matched, the target message may be the first message of a data flow. The virtual switch 201 forwards the target message following a processing flow of the first message according to the information to be matched of the target message, specifically including: according to a process of matching the information to be matched of the target message in a routing table, Access Control List (ACL) table, and rate limiting table in sequence, finally, matched routing information, ACL policy, and rate limiting policy of the target message are obtained, and the target message is forwarded according to the matched routing information, ACL policy, and rate limiting policy. In this embodiment, a case where no flow table entry is matched is considered as a first slowpath mode, which includes: a message parsing process of the message parsing acceleration module 202, a process of the virtual switch 201 matching the routing table, ACL table, and rate limiting table, and a process of forwarding message according to the matched routing information, ACL policy, and rate limiting policy.

Furthermore, in an implementation, the virtual switch 201 can generate a flow table entry corresponding to data flow to which the target message belongs according to the information to be matched of the target message and relevant information matched by the information to be matched in a processing flow of the first message, and add the flow table entry to the forwarding flow table. In this way, subsequent messages in the data flow can be processed by a fastpath mode, which improves the message forwarding speed. The relevant information matched by the information to be matched in the processing flow of the first message includes but is not limited to the routing information, ACL policy, and rate limiting policy that are matched according to the information to be matched of the target message. The information to be matched of the target message can be used as the matching information in the flow table entry corresponding to the data flow to which the target message belongs. The routing information, ACL policy, and rate limiting policy that are matched according to the information to be matched of the target message can be used as the action information in the flow table entry corresponding to the data flow to which the target message belongs.

It is explained here that in the pre-parsing process of the above implementation mode A1, the message parsing acceleration module 202 only parses the respective position offsets of the multiple protocol fields contained in the header information of the message. The virtual switch 201 in software form is responsible for extracting the information to be matched and the matching and action execution of the forwarding flow table, which can flexibly cope with the iteration and evolution of any upper-layer application. When the matching information and/or action required by the upper-layer application changes, the matching information and/or action information in the forwarding flow table can be flexibly adjusted. Accordingly, the virtual switch 201 can change the extracted information to be matched and adjust matching logic and action execution logic as needed. The pre-parsing process of the underlying hardware of the virtual switch 201 is not affected by the iteration and evolution of the upper-layer application. The virtual switch 201 assisted by hardware parses the header information of the message, which greatly improves the forwarding performance of the virtual switch 201.

Implementation mode A2: keyword parsing mode. In this implementation mode, after receiving the target message, the message parsing acceleration module 202 can perform keyword parsing on the header information of the target message to obtain a value of each protocol field corresponding to a specified protocol type in the header information; and generate the metadata information according to the value of each protocol field corresponding to the specified protocol type in the header information. The keyword parsing refers to a parsing process of parsing the header information of the target message to obtain the value of each protocol field corresponding to the specified protocol type in the header information. In this embodiment, the metadata information includes at least the value of each protocol field corresponding to the specified protocol type contained in the header information of the target message, that is, the information to be matched of the target message.

Specifically, the message parsing acceleration module 202 needs to store the specified protocol type required by the upper-layer application in advance. On this basis, the target message is sent to the message parsing acceleration module 202 when it reaches the programmable network card device. Then the message parsing acceleration module 202 perform keyword parsing on the header information of the target message in hardware mode to obtain the value of each protocol field corresponding to the specified protocol type in the header information of the message. In an implementation, the message parsing acceleration module 202 first pre-parses the header information of the target message, obtains the position offset and protocol type information of each protocol field from outside to inside in the header information of the message, and saves the position offset and protocol type information of each protocol field. Then, the position offset of the protocol field belonging to the specified protocol type is determined. According to the position offset of the protocol field belonging to the specified protocol type, the value of each protocol field of the specified protocol type is extracted from the header information of the target message as the metadata information of the target message. Alternatively, in an implementation, the message parsing acceleration module 202 gradually parses the header information of the target message from the outside to the inside. Every time it parses a protocol field, it determines whether the protocol field belongs to the specified protocol type. Until the protocol field belongs to the specified protocol type is parsed, the value of these protocol fields is used as the metadata information of the target message.

The specified protocol type can be determined according to the requirements of the upper-layer application. For example, it can be one of L3 protocol type (such as IP protocol), L4 protocol type (such as TCP or UDP protocol), L2 protocol type (such as MAC protocol), or tunnel protocol type (such as vlan or vxlan) or a combination thereof. The value of each protocol field corresponding to the specified protocol type varies according to different specified protocol types. For example, if the specified protocol type is L4 protocol type in the message structure shown in FIG. 2b or FIG. 2c, the value of each protocol field corresponding to the specified protocol type is implemented as hexatuples (source IP, destination IP, L4 protocol type, source port, destination port, VNI). The VNI is a Vxlan Network Identifier that represents a broadcast domain in a vlan or vxlan network. For example, if the specified protocol type is the L4 protocol type in the message structure shown in FIG. 2a, the value of each protocol field corresponding to the specified protocol type is implemented as a quintuple (source IP address, destination IP address, L4 protocol type, source port, and destination port).

After obtaining the metadata information of the target message, the message parsing acceleration module 202 writes the target message and the metadata information to the hardware message queue 203 for the virtual switch 201 to read. In implementation mode A2, the virtual switch 201 reads the target message and metadata information from the hardware message queue 203, obtains the value of each protocol field corresponding to the specified protocol type in the metadata information, and directly acts as the information to be matched.

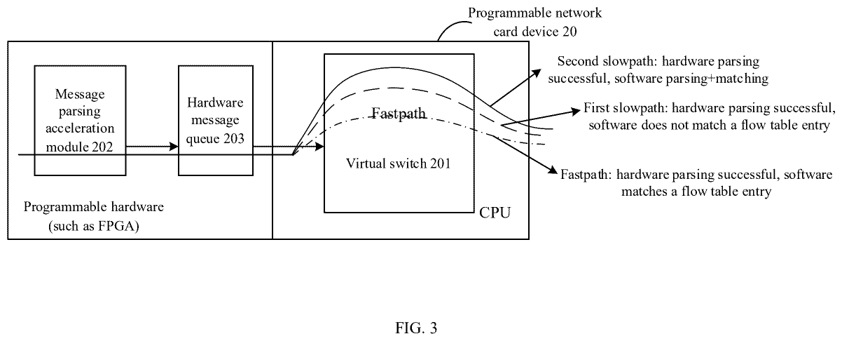

After obtaining the information to be matched, the virtual switch 201 matches the information to be matched in the forwarding flow table. Specifically, the information to be matched is matched with the matching information in each flow table entry in the forwarding flow table. If a flow table entry is matched, the target message is forwarded according to action information in the matched flow table entry. In this embodiment, as shown in FIG. 3, the matching of the flow table entry is regarded as a fastpath mode, which includes the message parsing process of the message parsing acceleration module 202, the process of the virtual switch 201 matching the forwarding flow table, and the process of forwarding the message according to the matched flow table entry.

Furthermore, in an implementation, if no flow table entry is matched, the target message may be the first message of a data flow. The virtual switch 201 forwards the target message following a processing flow of the first message according to the information to be matched of the target message, specifically including: according to a process of matching the information to be matched of the target message in a routing table, ACL table, and rate limiting table in sequence, finally, matched routing information, ACL policy, and rate limiting policy of the target message are obtained, and the target message is forwarded according to the matched routing information, ACL policy, and rate limiting policy. In this embodiment, as shown in FIG. 3, a case where no flow table entry is matched is considered as the first slowpath mode, which includes: a message parsing process of the message parsing acceleration module 202, a process of the virtual switch 201 matching the routing table, ACL table, and rate limiting table, and a process of forwarding message according to the matched routing information, ACL policy, and rate limiting policy.

Furthermore, in an implementation, the virtual switch 201 can generate a flow table entry corresponding to data flow to which the target message belongs according to the information to be matched of the target message and relevant information matched by the information to be matched in a processing flow of the first message, and add the flow table entry to the forwarding flow table. In this way, subsequent messages in the data flow can be processed by a fastpath mode, which improves the message forwarding speed. The relevant information matched by the information to be matched in the processing flow of the first message includes but is not limited to the routing information, ACL policy, and rate limiting policy that are matched according to the information to be matched of the target message. The information to be matched of the target message can be used as the matching information in the flow table entry corresponding to the data flow to which the target message belongs. The routing information, ACL policy, and rate limiting policy that are matched according to the information to be matched of the target message can be used as the action information in the flow table entry corresponding to the data flow to which the target message belongs.

It is explained here that in the keyword parsing process of the above implementation mode A2, the message parsing acceleration module 202 can obtain the information to be matched from the header information of the message as the metadata information according to the specified protocol type, and the virtual switch 201 in software form is responsible for the matching and action execution of the forwarding flow table based on the information to be matched. It can flexibly respond to some upper-layer applications that require iteration and evolution of message processing actions. When the message processing actions required by the upper-layer application change, the action information in the forwarding flow table can be flexibly adjusted. Accordingly, the virtual switch 201 can adjust the action execution logic as required. The keyword parsing process of the underlying hardware of the virtual switch 201 is not affected by the iteration and evolution of the upper-layer application. The virtual switch 201 assisted by hardware parses the header information of the message, which greatly improves the forwarding performance of the virtual switch 201.

Whether in the above implementation mode A1 or A2, the message parsing acceleration module 202 is further configured to: generate parsed additional information according to a parsing result of the header information of the target message, and use the parsed additional information as part of the metadata information. In the above implementation mode A1, the parsing result of the header information of the target message refers to the respective position offset of the multiple protocol fields in the header information of the target message, and further includes the protocol type information of each protocol field, as shown in FIG. 2a to FIG. 2c. In the implementation mode A2, the parsing result of the header information of the target message refers to the value of each protocol field corresponding to the specified protocol type in the header information of the target message, that is, the information to be matched.

Regardless of the implementation mode, the parsed additional information can include but is not limited to: at least one of first identifier information indicating whether the target message supports hardware parsing, second identifier information indicating whether the parsing result is incorrect in a case that the target message supports hardware parsing, and protocol characteristic information of the target message parsed in a case that the parsing result is not incorrect.

If the target message can be parsed by the message parsing acceleration module 202, it indicates that the target message supports hardware parsing, then a value of the first identifier information can be a first value, for example, 1. If the target message cannot be parsed by the message parsing acceleration module 202, it indicates that the target message does not support hardware parsing, then the value of the first identifier information can be a second value, for example, 0. The values of the first and second values are not limited, and 1 and 0 are only examples. In FIG. 2a to FIG. 2c, the first identifier information is represented by unit8_t parse_enable.

In the case that the target message supports hardware parsing, if no error is reported during the process that the message parsing acceleration module 202 parses the target message, it indicates that the parsing result is not incorrect, then the second identifier information can be a third value, for example, 1. If an error is reported during the process that the message parsing acceleration module 202 parses the target message, it indicates that the parsing result is incorrect, then the second identifier information can be a fourth value, for example, 0. The values of the third and fourth values are not limited, and 1 and 0 are only examples. In FIG. 2a to FIG. 2c, the second identifier information is represented by parse_error.

In a case that the parsing result is not incorrect, the parsed protocol characteristic information of the target messages can be used as the parsed additional information. In this embodiment, the protocol characteristic information of the target message mainly refers to whether the target message is a double-layer message in a logical network (overlay). The double-layer message refers to a message that support inner and outer double-layer protocols, such as the message shown in FIG. 2b and FIG. 2c. If the header information of the target message contains the inner and outer double-layer protocol fields, a value of the protocol characteristic information is 1. If the header information of the target message contains one layer protocol field, the value of the protocol characteristic information is 0. In FIG. 2a to FIG. 2c, the protocol characteristic information is represented by outer_vlaid.

For the message parsing acceleration module 202, the parsing result of the header information of the target message and the parsed additional information generated according to the parsing result are written to the hardware message queue 203 as the metadata information. Furthermore, in an implementation, as shown in FIG. 2a to FIG. 2c, in addition to unit8_t parse_enable, parse_error and outer_vlaid fields, the parsed additional information further includes a reserved field, that is, parse_reserv, for adding more parsed additional information.

Based on the above parsed additional information, the virtual switch 201 first determines whether the target message supports hardware parsing according to the parsed additional information in the metadata information, whether the parsing structure is incorrect in a case that the target message supports hardware parsing, and whether the target message is a double-layer message containing inner and outer double-layer protocol fields in a case that the parsing result is not incorrect.

In a case that it is determined, according to the parsed additional information, that the target message supports hardware parsing and that the parsing result is not incorrect in the case that hardware parsing is supported, the virtual switch 201 can read the target message and the metadata information from the hardware message queue 203 according to information of whether the target message contains the double-layer message of the inner and outer double-layer protocol fields. Then, the implementation mode A1 or A2 is used to obtain the information to be matched of the target message according to the metadata information. The information to be matched is matched in the forwarding flow table, and the target message is forwarded according to the matched flow table entry.

Furthermore, in an implementation, in a case that it is determined, according to the parsed additional information, that the target message does not support hardware parsing or that the target message supports hardware parsing but the parsing result is incorrect, the virtual switch 201 needs to perform keyword parsing on the header information of the target message to obtain a value of each protocol field corresponding to a specified protocol type in the header information as the information to be matched; and match the information to be matched in the forwarding flow table, and forward the target message according to the matched flow table entry. In other words, in a case that the hardware cannot parse the header information of the target message or a parsing error occurs, the virtual switch 201 needs to parse the header information of the target message in software mode.

Further, after performing keyword parsing on the header information of the target message to obtain the information to be matched, the virtual switch 201 matches the information to be matched in the forwarding flow table. If a flow table entry is matched, the target message is forwarded according to the action information in the matched flow table entry. If no flow table entry is matched, the target message may be the first message of a data flow. The virtual switch 201 forwards the target message following a processing flow of the first message according to the information to be matched of the target message, specifically including: according to a process of matching the information to be matched of the target message in a routing table, ACL table, and rate limiting table in sequence, finally, matched routing information, ACL policy, and rate limiting policy of the target message are obtained, and the target message is forwarded according to the matched routing information, ACL policy, and rate limiting policy. Furthermore, in an implementation, the virtual switch 201 can generate a flow table entry corresponding to data flow to which the target message belongs according to the information to be matched of the target message and relevant information matched by the information to be matched in a processing flow of the first message, and add the flow table entry to the forwarding flow table. In this way, subsequent messages in the data flow can be processed by a fastpath mode, which improves the message forwarding speed.

In this embodiment, as shown in FIG. 3, a message processing flow in a case that the target message does not support hardware parsing or the target message supports hardware parsing but the parsing result is incorrect can be called a second slowpath mode, which includes: a message parsing process of the message parsing acceleration module 202, a process that the virtual switch 201 parses the message again in software form, a process of matching the forwarding flow table, forwarding the message according to the matched flow table entry, and a process of matching the routing table, ACL table, and rate limiting table when no flow table entry is matched, a process of forwarding message according to the matched routing information, ACL policy, and rate limiting policy.

In the above or below embodiments of the present disclosure, the programmable network card device 20 is implemented with the message parsing acceleration module 202, the hardware message queue 203, and the virtual switch 201. In an implementation, the programmable network card device 20 further includes a physical network card of a physical machine implemented with programmable hardware, as shown in FIG. 1. On this basis, different scenarios in which physical servers transmit messages are illustrated as follows:

an upper-layer application in a virtual machine K generates a first message, and needs to sends the first message to a virtual machine J, which, after processing the first message, needs to forwards the first message to a virtual machine H.

If the virtual machine J and the virtual machine K reside on the same physical server, the virtual machine K sends the first message to the message parsing acceleration module 202 on the same physical server through its virtual network card. The message parsing acceleration module 202 parses header information of the first message to obtain metadata information, and writes the first message and the metadata information to a hardware message queue. The virtual switch 201 reads the first message and the metadata information from the hardware message queue, obtains information to be matched according to the metadata information with the above implementation mode A1 or A2, matches the information to be matched in a local forwarding flow table, and sends the first message to the virtual machine J through a virtual network card of the virtual machine J in a case that a flow table entry corresponding to the virtual machine J is matched.

If the virtual machine J and the virtual machine K reside on different physical servers, the virtual machine K sends the first message to the message parsing acceleration module 202 on the physical server to which it belongs through its virtual network card. The message parsing acceleration module 202 parses header information of the first message to obtain metadata information, and writes the first message and the metadata information to a hardware message queue. The virtual switch 201 on the physical server to which the virtual machine K belongs reads the first message and the metadata information from the hardware message queue, obtains information to be matched according to the metadata information with the above implementation mode A1 or A2, and matches the information to be matched in a local forwarding flow table, and sends the first message to the physical network card of the physical server to which the virtual machine K belongs in a case that the flow table entry corresponding to the physical server to which the virtual machine J belongs is matched. The physical network card provides the first message to the physical network card of the physical server to which the virtual machine J belongs through network. The physical network card provides the first message to the message parsing acceleration module 202 of the physical server to which the virtual machine J belongs. Further, the message parsing acceleration module 202 of the physical server to which the virtual machine J belongs receives the first message. The message parsing acceleration module 202 parses the header information of the first message to obtain the metadata information, and writes the first message and metadata information to the hardware message queue. The virtual switch 201 on the physical server to which the virtual machine J belongs reads the first message and the metadata information from the hardware message queue, and obtains the information to be matched according to the metadata information with the above implementation mode A1 or A2, and matches the information to be matched in the local forwarding flow table, and provides the first message to the virtual machine J through the virtual network card of the virtual machine J in a case that the flow table entry corresponding to the virtual machine J is matched.

After receiving the first message, the virtual machine J processes the first message to obtain a processed first message, and sends the processed first message to the virtual machine H. A process that the virtual machine J sends the processed first message to the virtual machine H is the same or similar to a process that the virtual machine J receives the first message sent by the virtual machine K, which is further divided into two cases that the virtual machine J and the virtual machine H reside on the same physical server or on different physical servers, which will not be repeated here.

In the embodiments of the present disclosure, the physical server, in addition to the above components, further includes other components, such as a memory, a communication component and a power supply module, which are not shown in FIG. 1. The memory is configured to store computer programs and can be configured to store various other data to support operations on the physical server. Examples of this data include instructions for any application or method operating on the physical server.

The memory can be implemented by any type of volatile or non-volatile storage device or a combination of them, such as static random access memory (SRAM), electrically erasable programmable read-only memory (EEPROM), erasable programmable read-only memory (EPROM), programmable read-only memory (PROM), read-only memory (ROM), static random access memory (SRAM), magnetic memory, flash memory, disk or CD.

The communication component is configured to facilitate wired or wireless communication between a device where the communication component resides and other devices. The device where the communication component resides can access wireless networks based on communication standards, such as WiFi, 2G, 3G, 4G/LTE, 5G and other mobile communication networks, or a combination of them. In one exemplary embodiment, the communication component receives broadcast signals or broadcast-related information from an outer broadcast management system via a broadcast channel. In one exemplary embodiment, the communication component further includes a near-field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

The power supply module provides power for various components of the device where the power supply module resides. The power supply module may include a power supply management system, one or more power supplies, and other components associated with generating, managing, and distributing power to the device on which the power supply module resides.

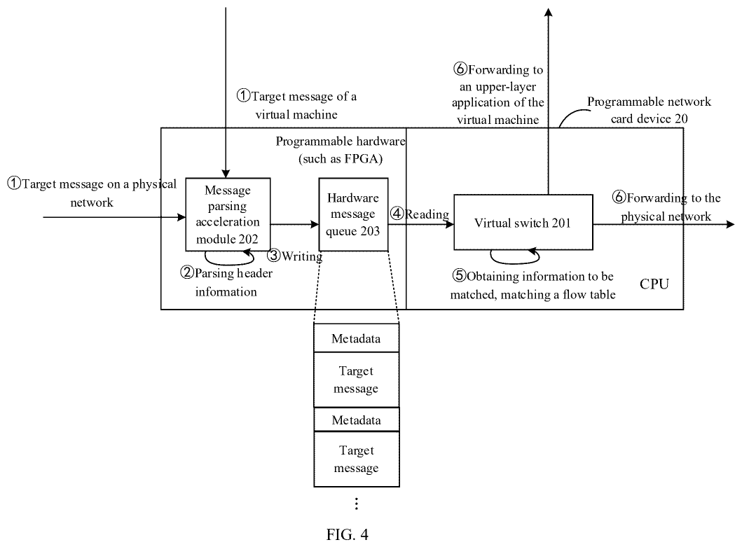

In addition to the physical server mentioned above, an embodiment of the present disclosure further provides a programmable network card device, as shown in FIG. 4, a virtual switch 201 for data forwarding between different virtual machines is deployed on a programmable network card device 20. The programmable network card device includes: a processor, and a message parsing acceleration module 202 and a hardware message queue 203 implemented based on programmable hardware.

The message parsing acceleration module 202 is configured to receive a target message that needs to be forwarded by the virtual switch 201, and parse header information of the target message to obtain metadata information of the target message, and write the target message and the metadata information to the hardware message queue 203 for the virtual switch 201 to read.

The virtual switch 201 runs on the processor and is configured to read the target message and the metadata information from the hardware message queue 203, obtain information to be matched of the target message according to the metadata information; and match the information to be matched in a forwarding flow table, and forward the target message according to a matched flow table entry.

In an embodiment, the message parsing acceleration module 202 is specifically configured to: pre-parse the header information of the target message to obtain respective position offsets of multiple protocol fields in the header information; and generate the metadata information according to the respective position offsets of the multiple protocol fields in the header information. Accordingly, the virtual switch 201 is specifically configured to: obtain a value of each protocol field corresponding to a specified protocol type from the header information of the target message as the information to be matched according to the respective position offsets of the multiple protocol fields in the metadata information.

In an embodiment, the message parsing acceleration module 202 is specifically configured to: perform keyword parsing on the header information of the target message to obtain a value of each protocol field corresponding to a specified protocol type in the header information; and generate the metadata information according to the value of each protocol field corresponding to the specified protocol type in the header information. Accordingly, the virtual switch 201 is specifically configured to: obtain the value of each protocol field corresponding to the specified protocol type in the metadata information as the information to be matched.

In an embodiment, the message parsing acceleration module 202 is further configured to: generate parsed additional information according to a parsing result of the header information of the target message, and use the parsed additional information as part of the metadata information. The parsed additional information includes at least one of first identifier information indicating whether the target message supports hardware parsing, second identifier information indicating whether the parsing result is incorrect in a case that the target message supports hardware parsing, and protocol characteristic information of the parsed target message.

In an embodiment, in a case that the target message does not support hardware parsing or the parsing result is incorrect, the virtual switch 201 is further configured to: perform keyword parsing on the header information of the target message to obtain a value of each protocol field corresponding to a specified protocol type in the header information as the information to be matched; and match the information to be matched in the forwarding flow table, and forward the target message according to the matched flow table entry.

In an embodiment, the virtual switch 201 is further configured to: in a case that no flow table entry is matched, forward the target message following a processing flow of a first message according to the information to be matched; and generate a flow table entry corresponding to data flow to which the target message belongs according to the information to be matched and relevant information matched by the information to be matched in the processing flow of the first message, and add the flow table entry to the forwarding flow table.

The programmable network card device provided by the embodiment of the present disclosure can deploy a virtual switch in software form, and includes a message parsing acceleration module and a hardware message queue implemented based on programmable hardware. A message that needs to be forwarded by the virtual switch first pass through the message parsing acceleration module. The message parsing acceleration module parses header information of the message and provides a parsing result to the virtual switch, which can greatly reduce the message parsing cost of the virtual switch and achieve high message forwarding performance. At the same time, all operations except parsing of the header information of the message are performed by the virtual switch in software form, which can meet flexible application requirements and ensure rapid iteration and evolution of the application requirements.

FIG. 5 is a flow schematic diagram of a message processing method provided by an exemplary embodiment of the present disclosure. The message processing method is applied to a physical server. The physical server includes a physical machine and a programmable network card device. A virtual machine is deployed on the physical machine, a virtual switch is deployed on the programmable network card device, and the programmable network card device includes a message parsing acceleration module and a hardware message queue implemented based on programmable hardware. The virtual switch is configured to forward data between different virtual machines. For details about each component of the physical server, refer to the previous embodiments and will not be repeated here. The method provided by this embodiment is described specifically from the perspective of the message parsing acceleration module on the programmable network card device of the physical server, as shown in FIG. 5. The method includes:
501: receiving a target message that needs to be forwarded by the virtual switch;
502: parsing header information of the target message to obtain metadata information of the target message; and
503: writing the target message and the metadata information to the hardware message queue for the virtual switch to obtain information to be matched of the target message according to the metadata information and forward the target message according to a flow table entry matched by the information to be matched in a forwarding flow table.

In an embodiment, the parsing the header information of the target message to obtain the metadata information of the target message includes: pre-parsing the header information of the target message to obtain respective position offsets of multiple protocol fields in the header information; and generating the metadata information of the target message according to the respective position offsets of the multiple protocol fields in the header information. In this embodiment, the metadata information of the target message includes the respective position offsets of the multiple protocol fields in the header information.

In another embodiment, the parsing the header information of the target message to obtain the metadata information of the target message includes: performing keyword parsing on the header information of the target message to obtain a value of each protocol field corresponding to a specified protocol type in the header information; and generating the metadata information of the target message according to the value of each protocol field corresponding to the specified protocol type in the header information. In this embodiment, the metadata information of the target message includes the value of each protocol field corresponding to the specified protocol type in the header information, such as quintuples and triples.

In the above embodiment, the respective position offsets of the multiple protocol fields in the header information or the value of each protocol field corresponding to the specified protocol type in the header information are parsing results of parsing the header information of the target message. In some embodiments, in addition to generating the metadata information of the target message according to a parsing result of the header information of the target message, parsed additional information can be generated according to the parsing result of the header information of the target message, and the parsed additional information can be used as part of the metadata information. In an implementation, the parsed additional information includes at least one of first identifier information indicating whether the target message supports hardware parsing, second identifier information indicating whether the parsing result is incorrect in a case that the target message supports hardware parsing, and protocol characteristic information of the parsed target message.

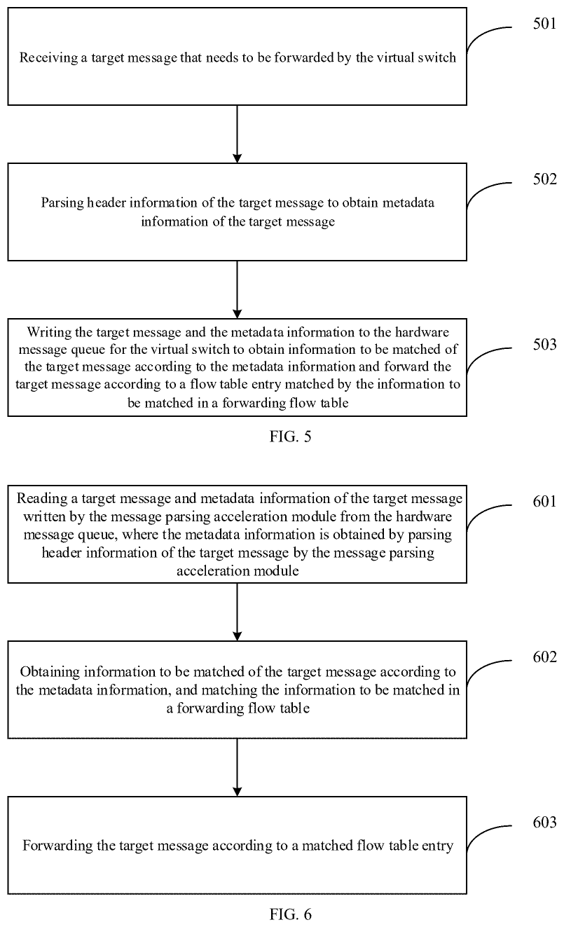

FIG. 6 is a flow schematic diagram of another message processing method provided by an exemplary embodiment of the present disclosure. The message processing method is applied to a physical server. The physical server includes a physical machine and a programmable network card device. A virtual machine is deployed on the physical machine, a virtual switch is deployed on the programmable network card device, and the programmable network card device includes a message parsing acceleration module and a hardware message queue implemented based on programmable hardware. The virtual switch is configured to forward data between different virtual machines. For details about each component of the physical server, refer to the previous embodiments and will not be repeated here. The method provided by this embodiment is described specifically from the perspective of the virtual switch deployed on the programmable network card device of the physical server. The virtual switch can run on a CPU of the programmable network card device. As shown in FIG. 6, the method includes:
601: reading a target message and metadata information of the target message written by the message parsing acceleration module from the hardware message queue, where the metadata information is obtained by parsing header information of the target message by the message parsing acceleration module;
602: obtaining information to be matched of the target message according to the metadata information, and matching the information to be matched in a forwarding flow table; and
603: forwarding the target message according to a matched flow table entry.

In an embodiment, the metadata information of the target message includes respective position offsets of multiple protocol fields in the header information. Based on this, the obtaining the information to be matched of the target message according to the metadata information includes: obtaining a value of each protocol field corresponding to a specified protocol type from the header information of the target message as the information to be matched according to the respective position offsets of the multiple protocol fields in the metadata information.

In another embodiment, the metadata information of the target message includes a value of each protocol field corresponding to the specified protocol type in the header information. Based on this, the obtaining the information to be matched of the target message according to the metadata information includes: obtaining the value of each protocol field corresponding to the specified protocol type in the metadata information as the information to be matched.

In an embodiment, the metadata information of the target message further includes: parsed additional information. In an implementation, the parsed additional information is generated according to a parsing result of the header information of the target message, and includes at least one of first identifier information indicating whether the target message supports hardware parsing, second identifier information indicating whether the parsing result is incorrect in a case that the target message supports hardware parsing, and protocol characteristic information of the parsed target message.

The virtual switch can further determine whether the target message supports hardware parsing according to the parsed additional information contained in the metadata information of the target message, whether the parsing structure is incorrect in a case that the target message supports hardware parsing, and whether the target message is a double-layer message containing inner and outer double-layer protocol fields in a case that the parsing result is not incorrect.

In a case that the target message does not support hardware parsing or the target message supports hardware parsing but the parsing result is incorrect, the method further includes: performing keyword parsing on the header information of the target message to obtain a value of each protocol field corresponding to a specified protocol type in the header information as the information to be matched; and matching the information to be matched in the forwarding flow table, and forwarding the target message according to the matched flow table entry.

Furthermore, in an implementation, the method further includes: in a case that no flow table entry is matched, forwarding the target message following a processing flow of a first message according to the information to be matched; and generating a flow table entry corresponding to data flow to which the target message belongs according to the information to be matched and relevant information matched by the information to be matched in the forwarding process, and add the flow table entry to the forwarding flow table.

In the message processing method provided by the above embodiment of the present disclosure, the virtual switch cooperates with the message parsing acceleration module and the hardware message queue implemented based on the programmable hardware on the programmable network card device. A message that needs to be forwarded by the virtual switch first pass through the message parsing acceleration module. The message parsing acceleration module parses header information of the message and provides a parsing result to the virtual switch, which can greatly reduce the message parsing cost of the virtual switch and achieve high message forwarding performance. At the same time, all operations except parsing of the header information of the message are performed by the virtual switch in software form, which can meet flexible application requirements and ensure rapid iteration and evolution of the application requirements.

It should be noted that some of the processes described in the above embodiments and in the accompanying drawings contain multiple operations that occur in a particular order, but it should be clearly understood that these operations may not be performed in the order in which they occur herein or in parallel, and that sequence numbers of the operations, such as 501, 502, etc., are merely used to distinguish the different operations. The sequence number itself does not represent any execution order. In addition, these processes can include more or fewer operations, and these operations can be executed sequentially or in parallel. It should be noted that the “first” and “second” descriptions in this article are used to distinguish between different messages, devices, modules, etc., and do not represent the order, nor do they limit the “first” and “second” to be different types.

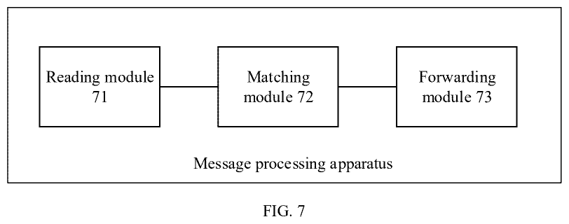

A structural diagram of a message processing apparatus provided by an exemplary embodiment of the present disclosure. As shown in FIG. 7, the message processing apparatus can be implemented in a virtual switch, including:
a reading module 71, configured to read a target message and metadata information of a target message written by a message parsing acceleration module from a hardware message queue, where the metadata information is obtained by parsing header information of the target message by the message parsing acceleration module;
a matching module 72, configured to obtain information to be matched of the target message according to the metadata information, and match the information to be matched in a forwarding flow table; and
a forwarding module 73: configured to forward the target message according to a flow table entry matched by the matching module.

All relevant contents of the steps involved in the method embodiments shown in FIG. 6 can be referred to the corresponding function description and will not be repeated here.

Accordingly, an embodiment of the present disclosure further provides a computer-readable storage medium storing a computer program, the computer program, when executed by a processor, enables the processor to implement the steps in the method shown in FIG. 6.

Accordingly, an embodiment of the present disclosure further provides a computer program product, including a computer program/instruction, the computer program/instruction, when executed by a processor, enables the processor to implement the steps in the method shown in FIG. 6.

Persons skilled in the art should understand that embodiments of the present disclosure may be provided as methods, systems, or computer program products. Therefore, the present disclosure may take the form of a full hardware embodiment, a full software embodiment, or a combination of software and hardware embodiments. Further, the present disclosure may take the form of a computer program product implemented on one or more computer available storage medium (including but not limited to disk memory, CD-ROM, optical memory, etc.) in which computer available program code is contained.

The present disclosure is described by reference to flow charts and/or block diagrams of methods, devices (systems), and computer program products according to embodiments of the present disclosure. It should be understood that each process and/or box in a flowchart and/or block diagram, and a combination of processes and/or boxes in a flowchart and/or block diagram, can be implemented by computer program instructions. These computer program instructions may be provided to a general-purpose computer, a special purpose computer, an embedded processor, or a processor of other programmable data processing devices to produce a machine, so that an apparatus that is configured to implement a function specified in one or more processes in a flowchart and/or one or more boxes in a block diagram is produced by instructions executed by the processor of a computer or other programmable data processing device

These computer program instructions may also be stored in computer-readable memory capable of directing a computer or other programmable data processing device to work in a particular manner such that the instructions stored in the computer-readable memory produce manufactured goods including instruction apparatus, the instruction apparatus implements a function specified in one or more processes in a flowchart and/or one or more boxes in a block diagram.

These computer program instructions may also be loaded onto a computer or other programmable data processing device, such that a series of operational steps are performed on the computer or other programmable data processing device to produce computer-implemented processing. Instructions that executed on the computer or other programmable device provide steps that used to implement a function specified in one or more processes in a flowchart and/or one or more boxes in a block diagram.

In a typical configuration, a computing device includes one or more central processing units (CPU), input/output interfaces, network interfaces, and memory. The memory may include forms of non-permanent memory in computer readable medium, random access memory (RAM) and/or non-volatile memory, for example, read-only memory (ROM) or flash memory (flash RAM). The memory is an example of a computer readable medium.

Computer readable medium, including permanent and non-permanent, removable and non-removable media, can be stored by any method or technology. Information can be computer-readable instructions, data structures, modules of programs, or other data. Examples of computer storage medium include, but not limited to phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassette tape, magnetic tape and disk storage or other magnetic storage device or any other non-transmission medium that may be used to store information that can be accessed by a computing device. As defined herein, computer-readable medium does not include transitory medium, such as modulated data signals and carriers.

It should also be noted that the term “include”, “contain” or any other variation thereof is intended to cover non-exclusive inclusion, so that a process, method, good or device including a set of elements includes not only those elements but also other elements not expressly listed or that are inherent to the process, method, good or device. In the absence of further restrictions, an element qualified by a sentence “including a . . . ” does not preclude the existence of additional identical elements in a process, method, product or device including the element.

The above is only an embodiment of the present disclosure and is not intended to restrict it. For those skilled in the art, the present disclosure is subject to various changes and variations. Any modification, equivalent replacement, improvement, etc. made within the spirit and principle of the present disclosure shall be included in the scope of the claims of the present disclosure.

1. A physical server, comprising: a physical machine and a programmable network card device, a virtual machine is deployed on the physical machine, and a virtual switch for data forwarding between different virtual machines is deployed on the programmable network card device;
wherein the programmable network card device comprises a message parsing acceleration module and a hardware message queue implemented based on programmable hardware; the message parsing acceleration module is configured to;
receive a target message that needs to be forwarded by the virtual switch,
parse header information of the target message to obtain metadata information of the target message, and
write the target message and the metadata information to the hardware message queue for the virtual switch to read;
wherein the virtual switch runs on a processor of the programmable network card device and is configured to:
read the target message and the metadata information from the hardware message queue,
obtain information to be matched of the target message according to the metadata information, and
match the information to be matched in a forwarding flow table, and forward the target message according to a matched flow table entry.

2. The physical server according to claim 1, wherein the message parsing acceleration module is specifically configured to:
pre-parse the header information of the target message to obtain respective position offsets of multiple protocol fields in the header information; and
generate the metadata information according to the respective position offsets of the multiple protocol fields in the header information.

3. The physical server according to claim 2, wherein the virtual switch is specifically configured to:
obtain a value of each protocol field corresponding to a specified protocol type from the header information of the target message as the information to be matched according to the respective position offsets of the multiple protocol fields in the metadata information.

4. The physical server according to claim 1, wherein the message parsing acceleration module is specifically configured to:
perform keyword parsing on the header information of the target message to obtain a value of each protocol field corresponding to a specified protocol type in the header information; and generate the metadata information according to the value of each protocol field corresponding to the specified protocol type in the header information;
the virtual switch is specifically configured to: obtain the value of each protocol field corresponding to the specified protocol type in the metadata information as the information to be matched.

5. The physical server according to claim 1, wherein the message parsing acceleration module is further configured to:
generate parsed additional information according to a parsing result of the header information of the target message, and use the parsed additional information as part of the metadata information;
the parsed additional information comprises at least one of first identifier information indicating whether the target message supports hardware parsing, second identifier information indicating whether the parsing result is incorrect in a case that the target message supports hardware parsing, and protocol characteristic information of the parsed target message.

6. The physical server according to claim 5, wherein in a case that the target message does not support hardware parsing or the parsing result is incorrect, the virtual switch 201 is further configured to:
perform keyword parsing on the header information of the target message to obtain a value of each protocol field corresponding to a specified protocol type in the header information as the information to be matched; and
match the information to be matched in the forwarding flow table, and forward the target message according to the matched flow table entry.

7. A programmable network card device, wherein a virtual switch for data forwarding between different virtual machines is deployed on the programmable network card device, the programmable network card device comprises: a processor, and a message parsing acceleration module and a hardware message queue implemented based on programmable hardware;
the message parsing acceleration module is configured to receive a target message that needs to be forwarded by the virtual switch, and parse header information of the target message to obtain metadata information of the target message; and write the target message and the metadata information to the hardware message queue for the virtual switch to read;
the virtual switch runs on the processor and is configured to read the target message and the metadata information from the hardware message queue, and obtain information to be matched of the target message according to the metadata information; and match the information to be matched in a forwarding flow table, and forward the target message according to a matched flow table entry.

8. The device according to claim 7, wherein the message parsing acceleration module is specifically configured to:
pre-parse the header information of the target message to obtain respective position offsets of multiple protocol fields in the header information; and
generate the metadata information according to the respective position offsets of the multiple protocol fields in the header information.

9. The device according to claim 8, wherein the virtual switch is specifically configured to:
obtain a value of each protocol field corresponding to a specified protocol type from the header information of the target message as the information to be matched according to the respective position offsets of the multiple protocol fields in the metadata information.

10. The device according to claim 7, wherein the message parsing acceleration module is specifically configured to:
perform keyword parsing on the header information of the target message to obtain a value of each protocol field corresponding to a specified protocol type in the header information; and generate the metadata information according to the value of each protocol field corresponding to the specified protocol type in the header information;
the virtual switch is specifically configured to: obtain the value of each protocol field corresponding to the specified protocol type in the metadata information as the information to be matched.

11. A message processing method, applied to a message parsing acceleration module implemented based on programmable hardware on a programmable network card device, a virtual switch is deployed on the programmable network card device, and the programmable network card device further comprises a hardware message queue implemented based on programmable hardware, the method comprises:
receiving a target message that needs to be forwarded by the virtual switch;
parsing header information of the target message to obtain metadata information of the target message; and
writing the target message and the metadata information to the hardware message queue for the virtual switch to obtain information to be matched of the target message according to the metadata information and forward the target message according to a flow table entry matched by the information to be matched in a forwarding flow table.

12. The method according to claim 11, wherein the parsing the header information of the target message to obtain the metadata information of the target message comprises:
pre-parsing the header information of the target message to obtain respective position offsets of multiple protocol fields in the header information; and
generating the metadata information according to the respective position offsets of the multiple protocol fields in the header information.

13. The method according to claim 11, wherein the parsing the header information of the target message to obtain the metadata information of the target message comprises:
performing keyword parsing on the header information of the target message to obtain a value of each protocol field corresponding to a specified protocol type in the header information; and
generating the metadata information according to the value of each protocol field corresponding to the specified protocol type in the header information.

14. The method according to claim 11, further comprising:
generating parsed additional information according to a parsing result of the header information of the target message, and using the parsed additional information as part of the metadata information;
the parsed additional information comprises at least one of first identifier information indicating whether the target message supports hardware parsing, second identifier information indicating whether the parsing result is incorrect in a case that the target message supports hardware parsing, and protocol characteristic information of the parsed target message.

15-16. (canceled)

17. A non-transitory computer-readable storage medium storing a computer program, wherein the computer program, when executed by a processor, causes the processor to implement the steps according to claim 11.

18. The physical server according to claim 2, wherein the message parsing acceleration module is further configured to:
generate parsed additional information according to a parsing result of the header information of the target message, and use the parsed additional information as part of the metadata information;
the parsed additional information comprises at least one of first identifier information indicating whether the target message supports hardware parsing, second identifier information indicating whether the parsing result is incorrect in a case that the target message supports hardware parsing, and protocol characteristic information of the parsed target message.

19. The method according to claim 12, further comprising:
generating parsed additional information according to a parsing result of the header information of the target message, and using the parsed additional information as part of the metadata information;
the parsed additional information comprises at least one of first identifier information indicating whether the target message supports hardware parsing, second identifier information indicating whether the parsing result is incorrect in a case that the target message supports hardware parsing, and protocol characteristic information of the parsed target message.

20. The non-transitory computer-readable storage medium according to claim 17, wherein the processor is configured to perform the following operations:
pre-parsing the header information of the target message to obtain respective position offsets of multiple protocol fields in the header information; and
generating the metadata information according to the respective position offsets of the multiple protocol fields in the header information.

21. The non-transitory computer-readable storage medium according to claim 17, wherein the processor is configured to perform the following operations:
performing keyword parsing on the header information of the target message to obtain a value of each protocol field corresponding to a specified protocol type in the header information; and
generating the metadata information according to the value of each protocol field corresponding to the specified protocol type in the header information.

22. The non-transitory computer-readable storage medium according to claim 17, wherein the processor is configured to perform the following operations:
generating parsed additional information according to a parsing result of the header information of the target message, and using the parsed additional information as part of the metadata information;
the parsed additional information comprises at least one of first identifier information indicating whether the target message supports hardware parsing, second identifier information indicating whether the parsing result is incorrect in a case that the target message supports hardware parsing, and protocol characteristic information of the parsed target message.
